(19) United States
(12) Patent Application Publication
(10) Pub. No.: US 2013/0039730 A1
(43) Pub. Date: Feb. 14, 2013

(54) ROBOT

(71) Applicants: Satoshi SUEYOSHI, Fukuoka (JP); Kentaro TANAKA, Fukuoka (JP); Yoshihiro KUSAMA, Fukuoka (JP); Tomohiro MATSUO, Fukuoka (JP)

(72) Inventors: Satoshi SUEYOSHI, Fukuoka (JP); Kentaro TANAKA, Fukuoka (JP); Yoshihiro KUSAMA, Fukuoka (JP); Tomohiro MATSUO, Fukuoka (JP)

(73) Assignee: KABUSHIKI KAISHA YASKAWA DENKI, Kitakyushu-shi (JP)

(21) Appl. No.: 13/558,348

(22) Filed: Jul. 26, 2012

(30) Foreign Application Priority Data
Aug. 8, 2011 (JP) 2011-172821

(51) Int. Cl. B25J 11/00; F16D 55/02; F16D 65/16; B66C 1/22

(52) U.S. Cl. 414/685; 188/72.3; 901/30; 901/23

(57) ABSTRACT

A robot includes a rotating electrical machine and a brake. The brake is configured to restrict rotation of the rotating electrical machine. The brake includes a brake plate, a plurality of pressing members, at least one biasing member, and an electromagnetic coil. The brake plate is configured to rotate integrally with a shaft of the rotating electrical machine. The plurality of pressing members are movable toward the brake plate and include a first pressing member and a second pressing member. The at least one biasing member is configured to bias the first pressing member and the second pressing member toward the brake plate using mutually different biasing forces. The electromagnetic coil is configured to, when current is on, electromagnetically attract the first pressing member and the second pressing member against the biasing forces of the at least one biasing member.

### CROSS-REFERENCE TO RELATED APPLICATIONS

The present application claims priority under 35 U.S.C. §119 to Japanese Patent Application No. 2011-172821, filed Aug. 8, 2011. The contents of this application are incorporated herein by reference in their entirety.

### BACKGROUND OF THE INVENTION

1. Field of the Invention

The present invention relates to a robot.

2. Discussion of the Background

A multiplicity of robots with rotating electrical machines such as motors have been used in manufacturing sites and other facilities. Japanese Unexamined Patent Application Publication No. 2008-307618 discloses a robot including a motor. The motor includes a brake such as a non-excitation actuated electromagnetic brake. The brake is for the purpose of preventing, when power is off, displacement due to gravity of the components of the robot such as arms.

A non-excitation actuated electromagnetic brake releases its braking force utilizing electromagnetic force when power is on, while when power is off, effects braking force utilizing mechanical action such as of springs.

### SUMMARY OF THE INVENTION

According to one aspect of the present invention, a robot includes a rotating electrical machine and a brake. The rotating electrical machine includes a shaft. The brake is configured to restrict rotation of the rotating electrical machine. The brake includes a brake plate, a plurality of pressing members, at least one biasing member, and an electromagnetic coil. The brake plate is configured to rotate integrally with the shaft of the rotating electrical machine. The plurality of pressing members are movable toward the brake plate and include a first pressing member and a second pressing member. The at least one biasing member is configured to bias the first pressing member and the second pressing member toward the brake plate using mutually different biasing forces. The electromagnetic coil is configured to, when current is on, electromagnetically attract the first pressing member and the second pressing member against the biasing forces of the at least one biasing member.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic perspective view of a robot according to embodiment 1;

FIG. 2 is a schematic side view of the robot;

FIG. 3 is a schematic cross-sectional view of a servo motor;

FIG. 4 is an enlarged cross-sectional view of an internal brake;

FIG. 5 is a front view of a pressing member according to embodiment 1;

FIG. 6 is an enlarged cross-sectional view of a third joint and other elements in the vicinity of the third joint;

FIG. 7 is a block diagram illustrating an exemplary configuration of a control device;

FIG. 8 is a flowchart of an exemplary procedure for a diagnosis;

FIG. 9 is a flowchart of an exemplary procedure for abnormality handling;

FIG. 10 is a front view of a pressing member according to embodiment 2;

FIG. 11 is a diagram illustrating an external brake according to embodiment 3;

FIG. 12 is a schematic perspective view of a robot according to embodiment 4; and

FIG. 13 is a partially enlarged view of a robot according to embodiment 5.

### DESCRIPTION OF THE EMBODIMENTS

The embodiments will now be described with reference to the accompanying drawings, wherein like reference numerals designate corresponding or identical elements throughout the various drawings.

### Embodiment 1

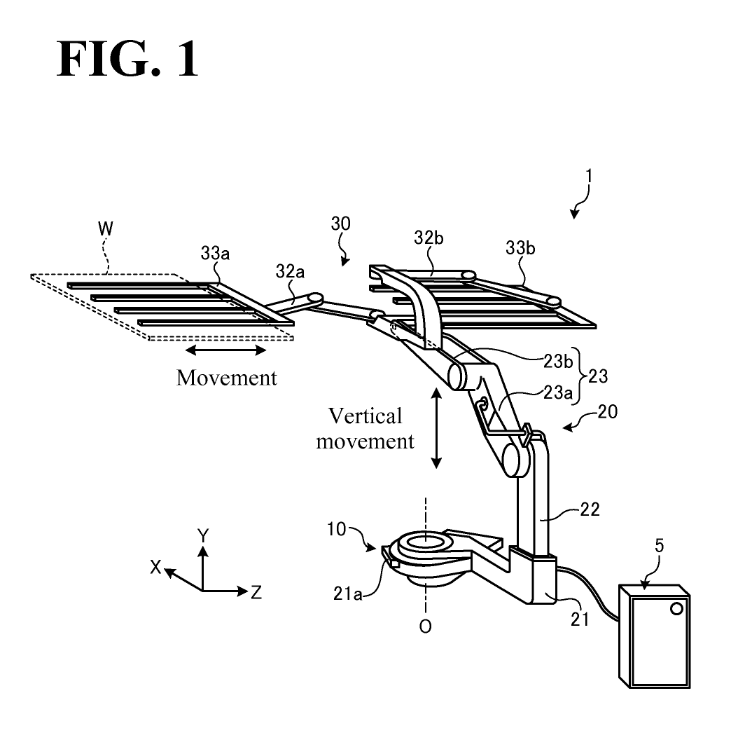

A robot according to embodiment 1 will be described by referring to FIG. 1. FIG. 1 is a schematic perspective view of the robot according to embodiment 1. In the following description, the direction Y shown in FIG. 1 is assumed the upper direction.

While the robot according to this embodiment is a transfer robot with two hands, this should not be construed as limiting the number of hands. For example, the transfer robot may have a single hand. Also in this embodiment, the objects to be conveyed on the hands are thin plate workpieces such as LCD glass substrates and substrates for solar power generation. This, however, should not be construed as limiting the objects to be conveyed.

As shown in FIG. 1, the robot 1 according to embodiment 1 includes a turning mechanism 10, an elevating mechanism 20, and a horizontal arm unit 30. The turning mechanism 10 turns the elevating mechanism 20 and the horizontal arm unit 30 about a perpendicular pivot axis O.

The elevating mechanism 20 includes a base 21, a pillar 22, and a leg unit 23. The pillar 22 is upright on the base 21. The leg unit 23 has a base end supported by the pillar 22 and a distal end supporting the horizontal arm unit 30. The leg unit 23 includes a first leg 23a and a second leg 23b. The first leg 23a has a base end rotatably supported at the pillar 22, which is upright at one end of the base 21. The second leg 23b has a base end rotatably supported by the distal end of the first leg 23a and a distal end rotatably supporting the horizontal arm unit 30.

The elevating mechanism 20 changes the posture of the leg unit 23 so as to move the horizontal arm unit 30 in vertical directions. The base 21 includes a stopper 21a to contact the horizontal arm unit 30 when the elevating mechanism 20 moves down to its lowest position.

The horizontal arm unit 30 includes hands 33a and 33b and arms 32a and 32b. The hands 33a and 33b carry workpieces W, which are objects to be conveyed. The arms 32a and 32b respectively support the hands 33a and 33b at the distal ends of the arms 32a and 32b. The horizontal arm unit 30 extends and retracts the arms 32a and 32b so as to move the hands 33a and 33b in predetermined directions. For example, when the robot 1 turns to the position shown in FIG. 1, the arms 32a and 32b linearly move the hands 33a and 33b in the direction Z.

When, for example, a workpiece W is stored in a stocker, not shown, the robot 1 according to embodiment 1 picks the workpiece W out of the stocker and conveys the workpiece W to a working area, not shown. While the following description is regarding conveyance by the hand 33a, the same applies to conveyance by the hand 33b.

First, the robot 1 uses the elevating mechanism 20 to move up or down the horizontal arm unit 30 and to position the hand 33a to a height slightly lower than the workpiece W to be taken out of the stocker.

Then, the robot 1 drives the arm 32a to linearly move the hand 33a in a horizontal direction and to insert the hand 33a into the stocker storing the workpiece W. The elevating mechanism 20 then moves up the horizontal arm unit 30, resulting in the workpiece W carried on the hand 33a.

Then, the robot 1 retracts the arm 32a to linearly withdraw the hand 33a carrying the workpiece W from the stocker in a horizontal direction. The robot 1 then uses the turning mechanism 10 to turn the horizontal arm unit 30 and the elevating mechanism 20 and to orient the distal end of the hand 33a toward the working area.

Then, the robot 1 again extends the arm 32a to linearly move the hand 33a in a horizontal direction and to make the hand 33a reach the working area. The robot 1 then uses the elevating mechanism 20 to move down the horizontal arm unit 30, thereby lowering the position of the hand 33a and placing the workpiece W in the working area.

Thus, the robot 1 conveys workpieces W by extending and retracting the arms 32a and 32b to move the hands 33a and 33b, by moving up and down the horizontal arm unit 30 using the elevating mechanism 20, and by turning the horizontal arm unit 30 using the turning mechanism 10.

The robot 1 makes these movements on instruction from a control device 5 coupled to the robot 1 through a communication network.

The control device 5 controls driving of the robot 1. Specifically, the robot 1 includes servo motors at the joints of the robot 1. The control device 5 controls the driving of the servo motors. On instruction from the control device 5, the robot 1 individually rotates the servo motors by certain degrees, thus driving the turning mechanism 10, the elevating mechanism 20, and the horizontal arm unit 30.

Examples of the communication network coupling the robot 1 and the control device 5 to one another include, but not limited to, common networks such as a wired Local Area Network (LAN) and a wireless LAN.

Each of the servo motors of the robot 1 includes a built-in brake to restrict rotation of the servo motor when driving power is off. Specifically, the brake includes a brake plate, a pressing member, a biasing member, and an electromagnetic coil. The brake plate rotates integrally with the shaft of the servo motor. The pressing member is movable to the brake plate. The biasing member biases the pressing member to the brake plate. The electromagnetic coil electromagnetically attracts the pressing member against the biasing force of the biasing member when current is on.

When current is off and the robot 1 turns into non-excitation state, the pressing member of the brake presses the brake plate utilizing the biasing force of the biasing member, thus restricting rotation of the brake plate. The restriction of rotation of the brake plate leads to restriction of rotation of the shaft, which is configured to rotate integrally with the brake plate. This keeps the current posture of the robot 1, and eliminates or minimizes displacement of the elevating mechanism 20 and the horizontal arm unit 30.

The braking force of the brake may degrade due to factors such as leakage of grease and deterioration over time of the brake shoe and the pressing member through friction. Conventional practice is to, for example, conduct periodic maintenance of the brake including replacement as necessary, in an attempt to prevent degradation of the braking force and to prevent displacement of the elevating mechanism 20 or other components caused by the degraded braking force. It is preferred, however, to more reliably prevent displacement of the elevating mechanism 20 or other components.

This is particularly true for embodiment 1 because the robot 1 according to embodiment 1 is of the type that supports the horizontal arm unit 30 on a single leg unit 23, as shown in FIG. 1. Although this configuration ensures simplicity, the elevating mechanism 20 or other components are more likely to be displaced due to the degraded braking force, compared with the type of robot including more than two leg units to support the horizontal arm unit 30. The robot 1 according to embodiment 1 conveys LCD glass substrates and substrates for solar power generation. This kind of robots have been using increasing sizes of arms in accordance with the increasing sizes of substrates. This makes the arms heavier, and makes displacement of the arms more likely to occur.

In view of this, the robot 1 according to embodiment 1 includes a plurality of pressing members to press the brake plate. This ensures that even when any of the pressing members stops functioning due to factors such as deterioration over time and failure, the rest of the pressing members properly function to prevent displacement due to gravity of the elevating mechanism 20 or other components.

The robot 1 according to embodiment 1 includes an additional brake outside the servo motor to restrict rotation of the servo motor, as well as the brake disposed inside the servo motor, in order to increase the braking force of the brake. This more reliably prevents displacement due to gravity of the elevating mechanism 20 or other components.

Description will be made with regard to a configuration and operations of the brakes in the robot 1 according to embodiment 1. The brake (first brake) disposed inside the servo motor will be hereinafter referred to as “internal brake”, while the brake (second brake) disposed outside the servo motor will be hereinafter referred to as “external brake”.

While in the following description the internal brake and the external brake are non-excitation actuated electromagnetic brakes, it is also possible to use other electromagnetic brakes than non-excitation actuated electromagnetic brakes.

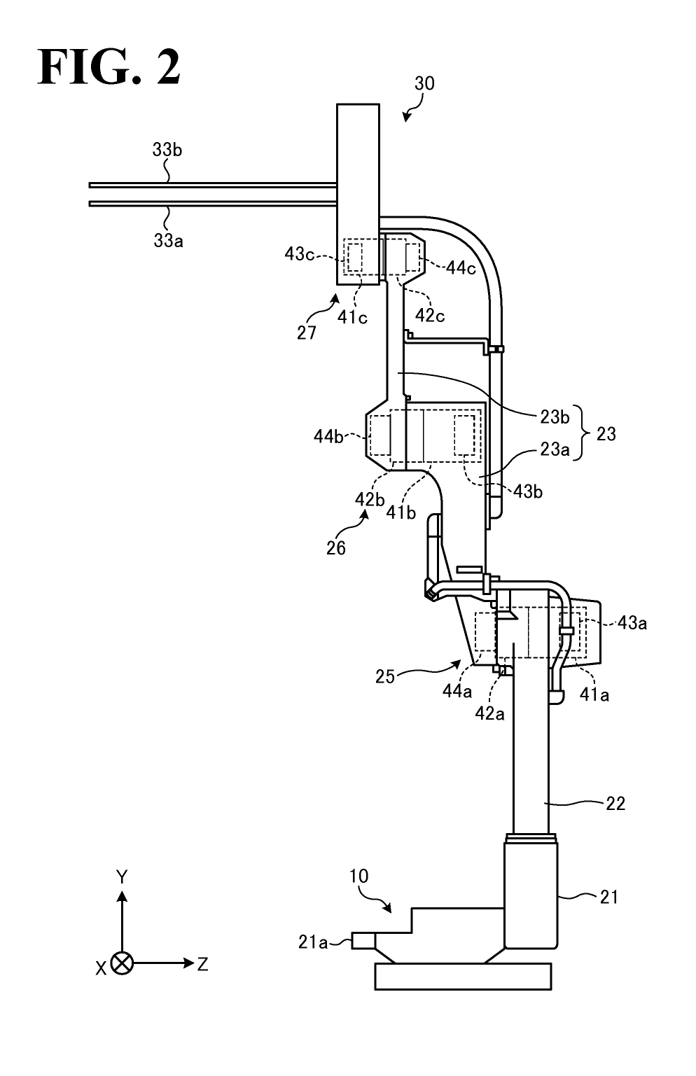

FIG. 2 is a schematic side view of the robot 1. As shown in FIG. 2, the robot 1 includes a first joint 25, a second joint 26, and a third joint 27.

The first joint 25 couples the base end of the first leg 23a to the distal end of the pillar 22 such that the base end of the first leg 23a is rotatable about a rotation axis parallel to the direction Z. The second joint 26 couples the base end of the second leg 23b to the distal end of the first leg 23a such that the base end of the second leg 23b is rotatable about a rotation axis parallel to the direction Z. The third joint 27 couples the horizontal arm unit 30 to the distal end of the second leg 23b such that the horizontal arm unit 30 is rotatable about a rotation axis parallel to the direction Z.

As shown in FIG. 2, the first joint 25 includes a servo motor 41a, a reducer 42a, and an external brake 44a. The second joint 26 includes a servo motor 41b, a reducer 42b, and an external brake 44b. The third joint 27 includes a servo motor 41c, a reducer 42c, and an external brake 44c. The servo motors 41a to 41c respectively include internal brakes 43a to 43c. The servo motors 41a to 41c are exemplary “rotating electrical machines”.

At the first joint 25, the rotation of the servo motor 41a is reduced by the reducer 42a, and the reduced rotation is output to the first leg 23a, causing the first leg 23a to turn and change its posture relative to the pillar 22. Also at the first joint 25, when power is off, the internal brake 43a and the external brake 44a are activated to keep the current posture of the first leg 23a relative to the pillar 22.

At the second joint 26, the rotation of the servo motor 41b is reduced by the reducer 42b, and the reduced rotation is output to the second leg 23b, causing the second leg 23b to turn and change its posture relative to the first leg 23a. At the second joint 26, when power is off, the internal brake 43b and the external brake 44b keep the current posture of the second leg 23b relative to the first leg 23a.

At the third joint 27, the rotation of the servo motor 41c is reduced by the reducer 42c, and the reduced rotation is output to the horizontal arm unit 30, causing the horizontal arm unit 30 to turn and change its posture relative to the second leg 23b. At the third joint 27, when power is off, the internal brake 43c and the external brake 44c keep the current posture of the horizontal arm unit 30 relative to the second leg 23b.

As shown in FIG. 2, the pillar 22, the leg unit 23, and the horizontal arm unit 30 are coupled to each other with the leg unit 23 positioned between the horizontal arm unit 30 and the pillar 22 as viewed from the direction X. That is, the horizontal arm unit 30, the second leg 23b, the first leg 23a, and the pillar 22 are disposed in the direction Z in this order. Each of these components is rotatably coupled to the next component.

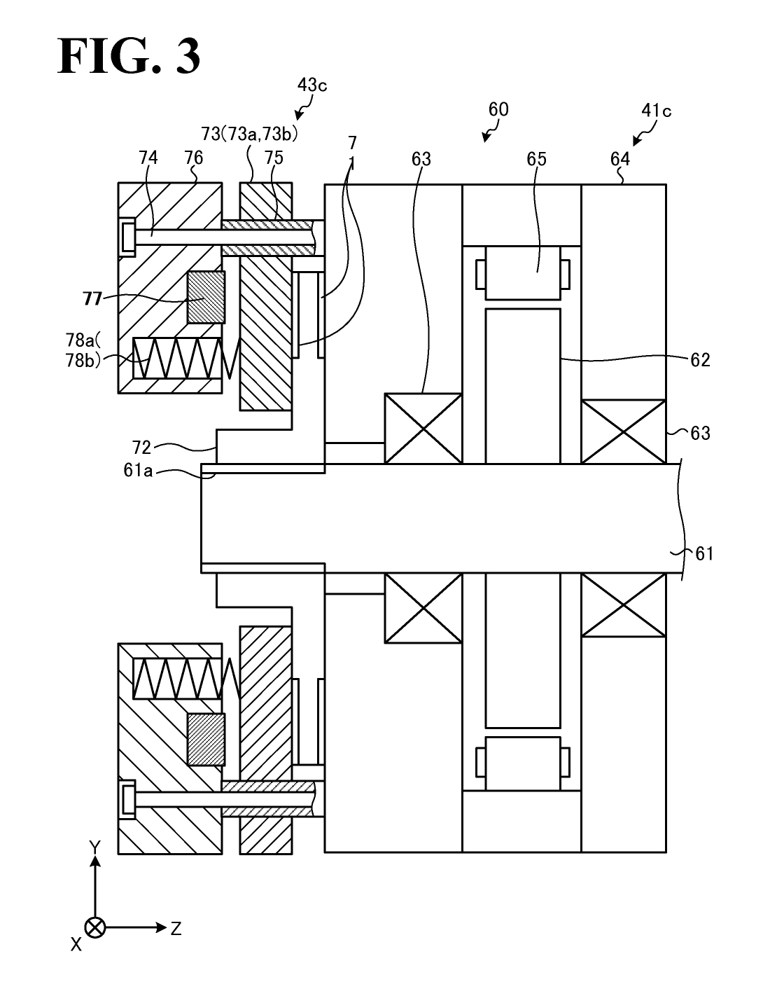

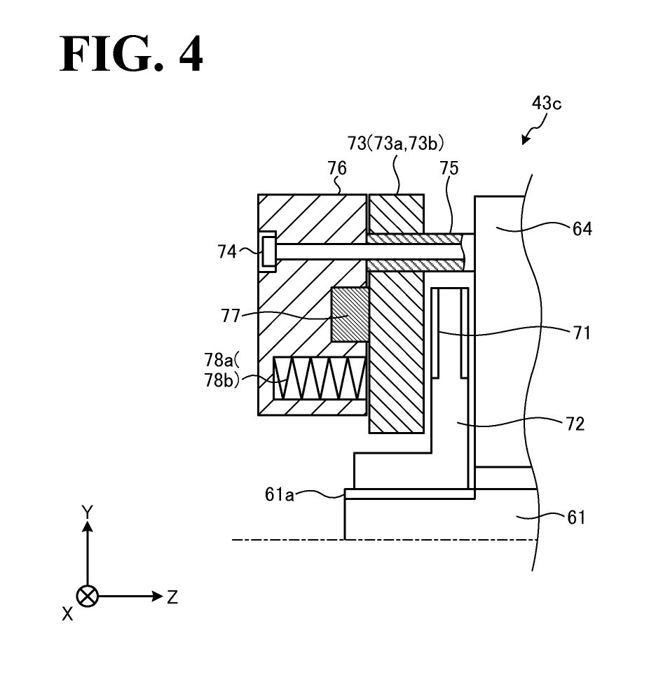

The servo motors 41a to 41c will be described in terms of their internal configuration. In the following description, an internal configuration of the servo motor 41c, which is disposed in the third joint 27, will be taken as an example. FIG. 3 is a schematic cross-sectional view of the servo motor 41c. FIG. 4 is an enlarged cross-sectional view of the internal brake 43c. The enlarged cross-sectional view shown in FIG. 4 is that of the internal brake 43c in brake released state.

As shown in FIG. 3, the servo motor 41c includes a motor main body 60 and the internal brake 43c. The motor main body 60 includes a shaft 61, a rotor 62, and two bearings 63. The shaft 61 extends in the direction Z. The rotor 62 is secured to the shaft 61 and rotates about the axis of the shaft 61. The bearings 63 sandwich the rotor 62 in the direction Z and rotatably support the shaft 61. The motor main body 60 includes a bracket 64 and a stator 65. The bracket 64 covers the rotor 62 and the bearings 63. The stator 65 is opposite the rotor 62 in the bracket 64.

In the motor main body 60, a predetermined voltage is applied to the coil of the stator 65, generating a rotational magnetic field on the stator 65. The rotational magnetic field interacts with a magnetic field generated by the permanent magnets of the rotor 62. This interaction causes the rotor 62 to rotate, which in turn causes the shaft 61 to rotate.

The shaft 61 includes a spline 61a extending in the direction Z at the distal end of the shaft 61 at its negative side in the direction Z (that is, the distal end of the shaft 61 at its internal brake 43c side). That is, the distal end of the shaft 61 is in the form of an external gear on the outer circumferential surface. The spline 61 a engages with an internal gear on the inner circumferential surface of a brake plate 72, described later. This causes the brake plate 72 to integrally rotate with the shaft 61.

The internal brake 43c includes brake shoes 71, the brake plate 72, a pressing member 73, bolts 74, a guide 75, and a field core 76.

The brake shoes 71 are made of rubber or other material of high friction resistance. The brake shoes 71 are disposed on the front surface and the rear surface of the brake plate 72 (that is, on the positive side and the negative side of the brake plate 72 in the direction Z). At the time of braking, the brake shoes 71 on the front surface contact the bracket 64, while the brake shoes 71 on the rear surface contact the pressing member 73.

The brake plate 72 is ring shaped and has an internal gear on the inner circumferential surface. The inner circumferential surface of the brake plate 72 engages with the spline 61a of the shaft 61, causing the brake plate 72 to integrally rotate with the shaft 61. The brake plate 72 is movable in the direction Z between the bracket 64 and the pressing member 73.

The pressing member 73 is disposed between the field core 76 and the brake plate 72, and is supported by the guide 75 movably between the field core 76 and the brake plate 72. The pressing member 73 is biased toward the brake plate 72 by helical compression springs 78a and 78b disposed on the field core 76.

The field core 76 is ring shaped and secured to the bracket 64 with the bolts 74. The field core 76 contains a soft magnetic material. The field core 76 includes an electromagnetic coil 77 and the helical compression springs 78a and 78b.

The electromagnetic coil 77 electromagnetically attracts the pressing member 73 when current is on, against the biasing forces of the helical compression springs 78a and 78b. The helical compression springs 78a and 78b bias the pressing member 73 toward the brake plate 72. The helical compression springs 78a and 78b are examples of a “biasing member” and a “spring”.

When current is applied through the electromagnetic coil 77, the internal brake 43c turns into excitation state. This makes the pressing member 73 magnetically attracted to the field core 76 against the biasing forces of the helical compression springs 78a and 78b, as shown in FIG. 4. This, in turn, releases the pressing force against the brake plate 72, making the shaft 61 rotatable.

When driving power is off and the internal brake 43c turns into non-excitation state, the pressing member 73 is pressed toward the bracket 64 by the biasing force of the helical compression springs 78a and 78b. This causes a friction force between the pressing member 73 and the opposing brake shoe 71 and a friction force between the bracket 64 and the opposing brake shoe 71. The friction forces restrict the rotation of the brake plate 72, which in turn restricts the rotation of the shaft 61.

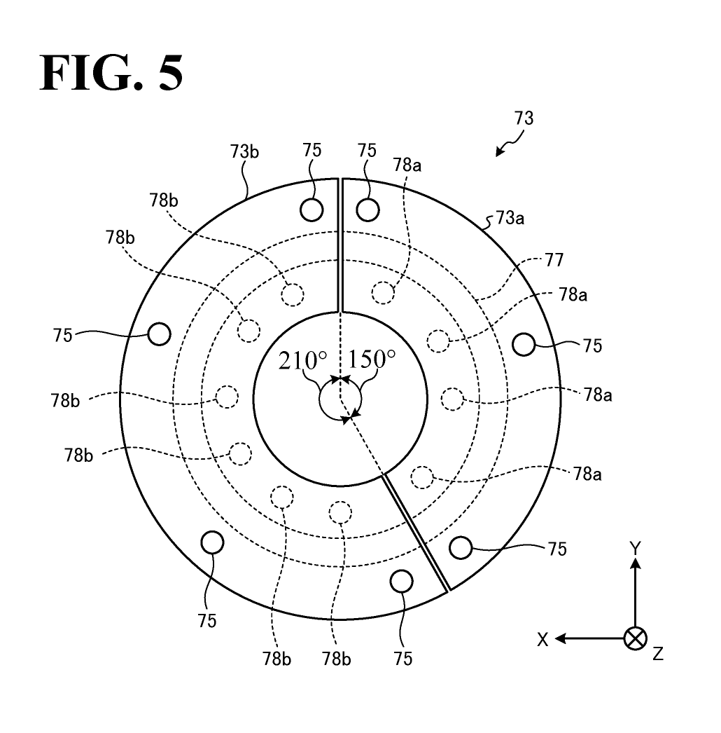

In embodiment 1, the pressing member 73, which presses the brake plate 72, includes two pressing members 73a and 73b. A configuration of the pressing member 73 will be described in detail by referring to FIG. 5. FIG. 5 is a front view of the pressing member 73 according to embodiment 1.

As shown in FIG. 5, the pressing member 73 defines a single ring shape in the front view (as seen in the direction Z). The ring shape is cut in the radial direction into the two pressing members 73a and 73b. That is, the two pressing members 73a and 73b constitute the single ring shaped pressing member 73.

The two pressing members 73a and 73b have mutually different central angles. That is, the pressing member 73 is divided such that the pressing members 73a and 73b have mutually different central angles along the circumferential direction of the pressing member 73. Specifically, the pressing member 73a has a central angle of approximately 150 degrees, while the pressing member 73b has a central angle of approximately 210 degrees.

Dividing the pressing member 73 in this manner makes the pressing area (surface area) of the pressing member 73a different from the pressing area (surface area) of the pressing member 73b. In this embodiment, the pressing area (surface area) of the pressing member 73b is larger than the pressing area (surface area) of the pressing member 73a.

In this embodiment, the central angle of the pressing member 73a is approximately 150 degrees, while the central angle of the pressing member 73b is approximately 210 degrees. This, however, should not be construed in a limiting sense. Any other central angles are possible insofar as the pressing member 73a and the pressing member 73b have mutually different central angles.

In this embodiment, the pressing area (surface area) of the pressing member 73b is larger than the pressing area (surface area) of the pressing member 73a. Contrarily, the pressing area (surface area) of the pressing member 73a may be larger than the pressing area (surface area) of the pressing member 73b. In this case, the pressing member 73 is divided such that the larger central angle of the pressing member 73a is larger than the central angle of the pressing member 73b.

The pressing member 73a receives the biasing force of the helical compression springs 78a, while the pressing member 73b receives the biasing force of the helical compression springs 78b, so as to press the brake plate 72. The spring constants of the helical compression springs 78a and the spring constants of the helical compression springs 78b are the same.

The number of the helical compression springs 78a is determined based on the pressing area (surface area) of the pressing member 73a. The number of the helical compression springs 78b is determined based on the pressing area (surface area) of the pressing member 73b, and is different from the number of the helical compression springs 78a. Specifically, four helical compression springs 78a are disposed to bias the pressing member 73a at a region of the pressing member 73a corresponding to the brake plate 72 (at a radially inner portion of the pressing member 73a). Six helical compression springs 78b are disposed to bias the pressing member 73b at a region of the pressing member 73b corresponding to the brake plate 72 (at a radially inner portion of the pressing member 73b).

Thus, the helical compression springs 78a and the helical compression springs 78b are the same in spring constant and different in number considering the area sizes of the pressing members 73a and 73b. This ensures that the pressing members 73a and 73b exert pressing forces that are determined based on the respective area sizes.

Making the pressing forces of the pressing members 73a and 73b mutually different means that the pressing members 73a and 73b exert the mutually different pressing forces on the brake plate 72. In the case shown in FIG. 5, the pressing force of the pressing member 73b is larger than the pressing force of the pressing member 73a.

In this embodiment, the helical compression springs 78a and 78b having the same spring constants are used to effect mutually different pressing forces of the pressing members 73a and 73b. This reduces the piece-part count of the internal brake 43c, compared with the use of helical compression springs having mutually different spring constants. The use of the helical compression springs 78a and 78b having the same spring constants also facilitates the differentiation of the pressing forces of the pressing members 73a and 73b, compared with the use of helical compression springs having mutually different spring constants.

As shown in FIG. 5, the pressing member 73a includes three guide holes 75 at a region of the pressing member 73a not overlapping with the brake plate 72 (at a ring shaped region further outward than the ring shaped region in which the helical compression springs 78a are disposed). The pressing member 73b includes four guide holes 75 at a region of the pressing member 73b not overlapping with the brake plate 72 (at a ring shaped region further outward than the ring shaped region in which the helical compression springs 78b are disposed).

Now that the configurations of the pressing members 73a and 73b have been described by referring to FIG. 5, the brake plate 72 will be described in detail regarding how it operates at the time of braking and at the time of releasing the brake.

In FIG. 3, the internal brake 43c is under braking operation of the brake plate 72, that is, no predetermined voltage is applied through the electromagnetic coil 77. In this state, the pressing members 73a and 73b respectively receive the biasing forces of the helical compression springs 78a and 78b, and press the brake plate 72 approximately simultaneously. As described above, the pressing force of the pressing member 73b is larger than the pressing force of the pressing member 73a.

Receiving the pressing forces of the pressing members 73a and 73b, the brake plate 72 is pressed against the bracket 64. This brings the brake shoe 71 on the side of the pressing members 73a and 73b into contact with the pressing members 73a and 73b, and brings the brake shoe 71 on the side of the bracket 64 into contact with the bracket 64.

This causes friction between the pressing members 73a and 73b and the opposing brake shoe 71 and friction between the bracket 64 and the opposing brake shoe 71. The frictions restrict the rotation of the brake plate 72, which in turn restricts the rotation of the shaft 61.

When the braking operation of the brake plate 72 is released, a predetermined voltage is applied through the electromagnetic coil 77, generating an electromagnetic force on the electromagnetic coil 77. The electromagnetic force attracts the pressing members 73a and 73b toward the electromagnetic coil 77 against the biasing forces of the helical compression springs 78a and 78b, as shown in FIG. 4.

In this respect, the smaller pressing force, which is received by the pressing member 73a in this embodiment, makes the pressing member 73a more rapidly attracted to the electromagnetic coil 77 than the pressing member 73b, which receives the larger pressing force in this embodiment. That is, a time lag exists between the timing at which the pressing member 73a releases its braking on the brake plate 72 and the timing at which the pressing member 73b releases its braking on the brake plate 72.

When both the pressing members 73a and 73b are separated from the brake plate 72, the friction force between the pressing member 73 and the opposing brake shoe 71 is released, and the friction force between the bracket 64 and the opposing brake shoe 71 is released. This, as a result, makes the brake plate 72 rotatable in conjunction with the rotation of the shaft 61. That is, the restricted rotation of the shaft 61 due to the internal brake 43c is released.

Embodiment 1 employs two pressing members, namely the pressing members 73a and 73b, to press the brake plate 72.

This ensures that in an example situation where one of the pressing member 73a and the pressing member 73b fails, the other, non-failing pressing member continues operating, as opposed to the use of a single pressing member. This more reliably prevents displacement of the elevating mechanism 20 or other components.

The pressing member 73a and the pressing member 73b have mutually different pressing forces. This makes a timing difference of wear-caused failure between the pressing members 73a and 73b. This, in turn, eliminates or minimizes simultaneous failure of the pressing members 73a and 73b.

The helical compression springs 78a and 78b are the same in spring constant and different in number considering the pressing area sizes of the pressing members 73a and 73b, which together define a ring shape. This ensures that the pressing members 73a and 73b exert mutually different pressing forces that are determined based on the respective pressing area sizes.

It is also possible to adjust, as necessary, the spring constants and the number of the helical compression springs 78a and 78b, or adjust the masses of the pressing members 73a and 73b while maintaining the difference between the pressing forces of the pressing members 73a and 73b. This ensures adjustment of the timings at which the pressing members 73a and 73b contact the brake plate 72 (specifically, the brake shoes 71).

If an adjustment is made so as to effect approximately simultaneous contact of the pressing member 73a and the pressing member 73b with the brake plate 72 (specifically, the brake shoe 71), the period of time for braking the rotation of the brake plate 72 is shortened.

If an adjustment is made so as to effect different timings at which the pressing member 73a and the pressing member 73b contact the brake plate 72 (the brake shoes 71), the braking force comes in a staged manner (two stages in this embodiment). This ensures smoother braking of the rotation of the brake plate 72, and reduces impacts and braking noise involved in braking

It should be noted that an adjustment may involve making the spring constants of the helical compression springs 78a and 78b mutually different. That is, the helical compression springs 78a and 78b may not necessarily have the same spring constants.

While in this embodiment the single pressing member 73 has two divisions, the number of divisions will not be limited to two. When the pressing member 73 has equal to or more than three pressing members, the helical compression springs may be disposed such that the pressing forces of at least two pressing members are different from one another. While in this embodiment the servo motor 41 c has been described as a representative example, the other servo motors 41a and 41b are similar to the servo motor 41c.

In this embodiment, the single pressing member 73 has two divisions of mutually different central angles, and this makes the pressing areas of the divisional pressing members 73a and 73b mutually different. This, however, should not be construed in a limiting sense. For example, it is also possible to use two divisional pressing members both having a central angle of 180 degrees but having mutually different radii. This also ensures that the two pressing members have mutually different pressing areas.

In this embodiment, the helical compression springs disposed on the pressing member 73a and the helical compression springs disposed on the pressing member 73b have the same spring constants and are mutually different in number, and this makes the pressing forces of the two pressing members 73a and 73b mutually different. This, however, should not be construed in a limiting sense. For example, the helical compression springs disposed on the pressing member 73a and the helical compression springs disposed on the pressing member 73b may have mutually different spring constants and may be the same in number. This also makes the pressing forces of the pressing members 73a and 73b mutually different.

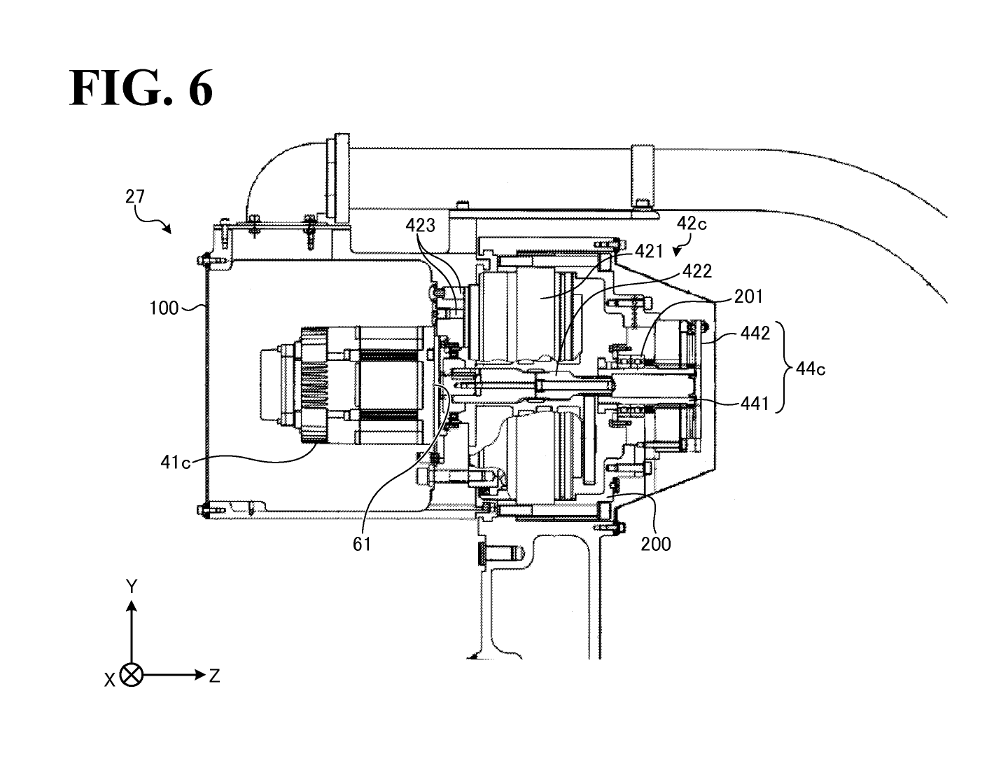

Next, the reducers 42a to 42c and the external brakes 44a to 44c will be described in detail. The reducer 42c and the external brake 44c, which are disposed at the third joint 27, will be described in detail here by referring to FIG. 6. FIG. 6 is an enlarged cross-sectional view of the third joint 27 and other elements in the vicinity of the third joint 27.

As shown in FIG. 6, in the third joint 27, the servo motor 41c is secured in a casing 100, which is at the side of the horizontal arm unit 30. The reducer 42c and the external brake 44c are secured in a casing 200, which is at the side of the second leg 23b.

The reducer 42c includes a cylindrical reducer main body 421, an input shaft 422, an output shaft 423. The input shaft 422 passes through the reducer main body 421. Examples of the reducer 42c include, but not limited to, a planetary roller reducer. The reducer main body 421 includes a sun roller, a planetary roller, and other elements.

The input shaft 422 has a base end coupled to the shaft 61 of the servo motor 41c. The input shaft 422 transmits rotation of the shaft 61 to the sun roller of the reducer main body 421. The output shaft 423 has a base end secured to the planetary roller of the reducer main body 421 and has a distal end secured to the casing 100.

In the reducer 42c, the sun roller rotates in conjunction with the rotation of the input shaft 422, while the planetary roller rotates about itself and revolves around the sun roller in conjunction with the rotation of the sun roller. The output shaft 423 rotates in conjunction with the revolution of the planetary roller, and this causes rotation of the horizontal arm unit 30 secured to the distal end of the output shaft 423. Thus, the posture of the horizontal arm unit 30 changes relative to the second leg 23b.

The reducer 42c is not limited to a planetary roller reducer; for example, a planetary gear reducer may be used. While in embodiment 1 the robot 1 includes the reducer 42c, the robot 1 may be without the reducer 42c.

The external brake 44c includes a brake shaft 441 and a brake main body 442. The brake shaft 441 has a base end coupled to the distal end of the input shaft 422 and is concentric to the input shaft 422.

Specifically, the brake shaft 441 has a base end in the form of an internal gear on the inner circumferential surface, while the input shaft 422 has a distal end in the form of an external gear on the outer circumferential surface. The distal end of the input shaft 422 engages with the base end of the brake shaft 441, integrating the input shaft 422 and the brake shaft 441. Thus, the brake shaft 441 rotates in conjunction with the rotation of the input shaft 422.

A bearing 201 is secured in the casing 200. The bearing 201 rotatably supports the brake shaft 441.

The brake main body 442 is a non-excitation actuated electromagnetic brake similar to the internal brake 43c, as shown in FIG. 3 and other drawings. That is, the brake main body 442 includes a brake plate, a field core, a pressing member, and helical compression springs. The brake plate rotates integrally with the brake shaft 441. The field core is secured to the casing 200 with bolts or other means. The pressing member is disposed between the field core and the brake plate. The helical compression springs bias the pressing member toward the brake plate.

The pressing member of the external brake 44c has two divisions, similarly to the pressing member 73 of the internal brake 43c. This ensures that even when, for example, one of the pressing members fails, the other, non-failing pressing member continues operating. This more reliably prevents displacement of the elevating mechanism 20 or other components.

In this embodiment, the pressing member of the brake main body 442 has a similar configuration to the pressing member of the internal brake 43c. This, however, should not be construed in a limiting sense. For example, the number of divisions of the pressing member of the brake main body 442 and the angles of the divisions may be different from the number of divisions of the pressing member 73 of the internal brake 43c and the angles of the divisions of the pressing member 73. The helical compression springs on the pressing member of the brake main body 442 may not necessarily be the same in number as the helical compression springs on the pressing member 73 of the internal brake 43c. Additionally, the pressing member of the brake main body 442 may not have any divisions.

Thus, the robot 1 according to embodiment 1 includes two brakes in one servo motor 41c, namely the internal brake 43c and the external brake 44c. This enhances the braking force compared with the use of the internal brake 43c alone to restrict rotation of the servo motor 41c.

Even when one of the internal brake 43c and the external brake 44c provides an insufficient braking force through wear over time or due to other factors, the other brake restricts the rotation of the servo motor 41c. This more reliably prevents displacement due to gravity of the horizontal arm unit 30.

As shown in FIG. 6, the external brake 44c restricts the rotation of the input shaft 422, instead of restricting the rotation of the output shaft 423. This is because the torque of the input shaft 422 is smaller than the torque of the output shaft 423, and restricting the rotation of the input shaft 422 using the external brake 44c ensures a reduction in size of the external brake, compared with restriction of the rotation of the output shaft 423.

The servo motor 41c, the reducer 42c, and the external brake 44c of the third joint 27 are respectively similar to the servo motor 41 a, the reducer 42a, and the external brake 44a of the first joint 25, and respectively similar to the servo motor 41b, the reducer 42b, and the external brake 44b of the second joint 26.

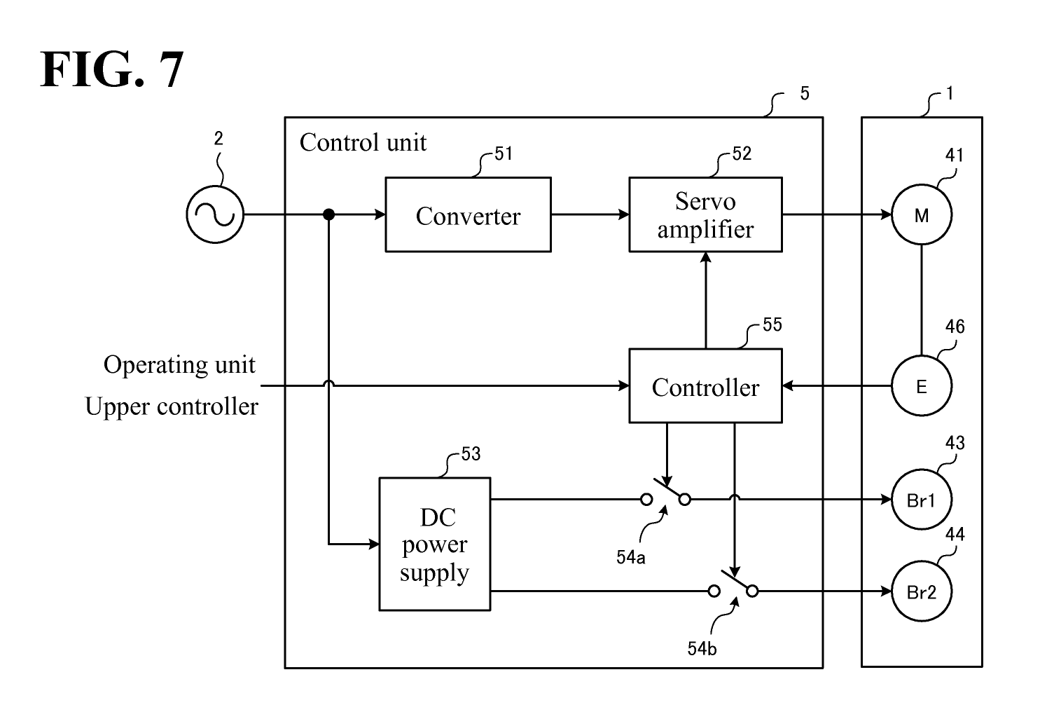

Next, the operation of the robot 1 as controlled by the control device 5 will be described by referring to FIGS. 7 to 9. The control device 5 according to embodiment 1 controls driving of the servo motors 4 and executes a diagnosis and abnormality handling. In the diagnosis, the control device 5 determines whether the internal brakes 43 and the external brakes 44 are functioning normally. When the control device 5 determines in the diagnosis that the internal brakes 43 or the external brakes 44 are not functioning normally, the control device 5 executes abnormality handling of causing the robot 1 to take an evacuation posture.

First, a configuration of the control device 5 will be described by referring to FIG. 7. FIG. 7 is a block diagram illustrating an exemplary configuration of the control device 5. FIG. 7 shows only those components necessary for an understanding of the operation of the control device 5.

As shown in FIG. 7, the control device 5 includes a converter 51, a servo amplifier 52, a DC power supply 53, switches 54a and 54b, and a controller 55.

As shown in FIG. 7, the robot 1 further includes encoders 46. The encoders 46 are position detectors to detect the rotation positions of the servo motors 41, and are dedicated to the respective servo motors 41. Each encoder 46 detects the rotation position (encoder value) of the corresponding servo motor 41 and outputs the detected rotation position to the controller 55.

While in this embodiment each encoder 46 is an absolute value encoder, this should not be construed in a limiting sense. The encoder 46 may be an incremental encoder. The encoder 46 may be replaced by some other position detector, such as a resolver.

The converter 51 receives a supply of alternating current (AC) power from an AC main power supply 2, and generates driving electric power for the servo motors 41 using the AC power. The driving electric power generated by the converter 51 is input to the servo amplifier 52. The servo amplifier 52, on instruction from the controller 55, executes PWM control and supplies the driving electric power to each servo motor 41.

The DC power supply 53 receives a supply of AC from the AC main power supply 2, and generates direct current (DC) power from the AC power. The DC power generated by the DC power supply 53 is supplied to the internal brake 43 and the external brake 44. The generated DC power is also supplied to the controller 55 and other components, not shown.

The switch 54a is an electric power switch dedicated to the internal brake 43. The switch 54a switches between ON and OFF of the DC power from the DC power supply 53 to the internal brake 43. The switch 54b is an electric power switch dedicated to the external brake 44. The switch 54b switches between ON and OFF of the DC power from the DC power supply 53 to the external brake 44.

The switching operations of the switches 54a and 54b are controlled by the controller 55. The internal brake 43 and the external brake 44 are activated by the OFF operation of the switches 54a and 54b, that is, activated when power is off, so as to restrict the rotation of the servo motor 41.

The controller 55 executes arithmetic operations necessary for the control of the servo motors 41 based on instruction data from an operating unit or an upper controller and based on the encoder value from the encoder 46. Examples of the operating unit include, but not limited to, a pendant. Examples of the upper controller include, but not limited to, a personal computer (PC). As a result of the arithmetic operations, the controller 55 generates a PWM waveform and outputs the generated PWM waveform to the servo amplifier 52. The servo amplifier 52 executes PWM control in accordance with the PWM waveform.

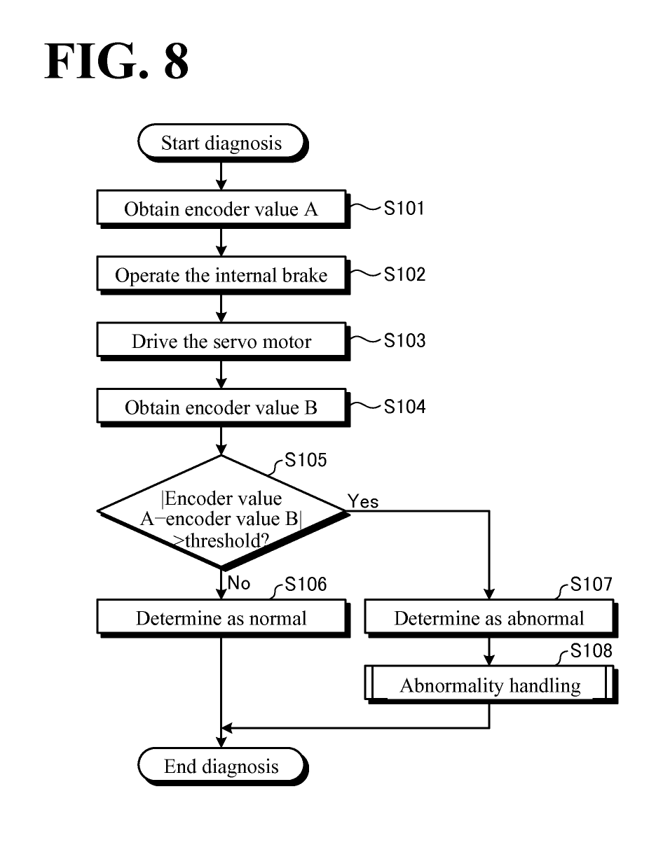

On instruction from the operating unit or the upper controller, the controller 55 executes a diagnosis of the internal brake 43 and the external brake 44. The diagnosis includes a determination, based on the encoder value obtained from the encoder 46, as to whether the internal brake 43 or the external brake 44 is functioning normally when the servo motor 41 is activated with the internal brake 43 or the external brake 44 in operation. A procedure for the diagnosis will be described in detail below by referring to FIG. 8.

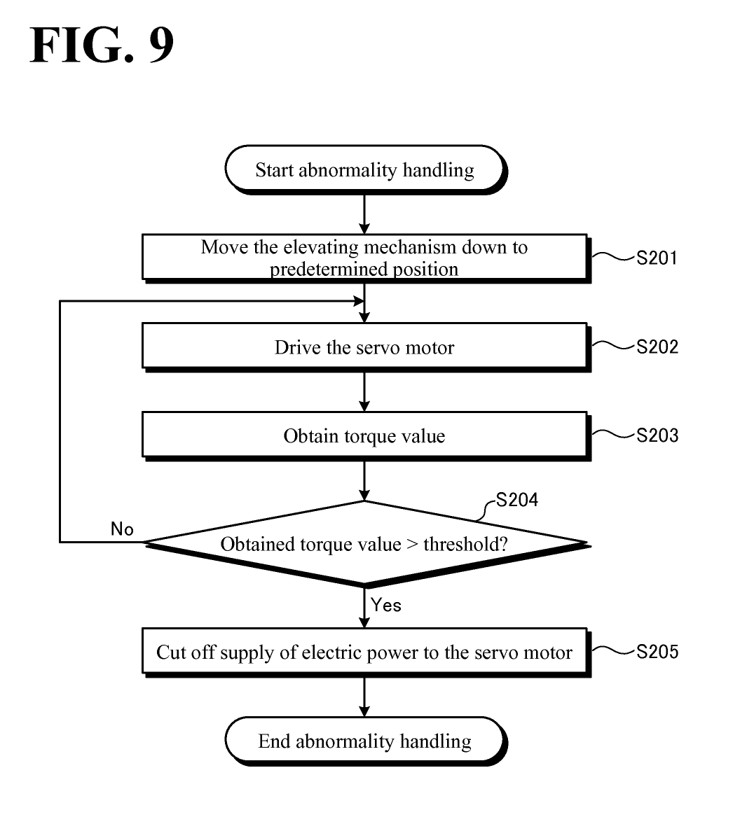

When in the diagnosis the controller 55 determines that the internal brake 43 or the external brake 44 is not functioning normally, the controller 55 executes abnormality handling. The term abnormality handling refers to moving down the elevating mechanism 20 to its lowest position and cutting off the supply of electric power to the servo motors 41. This is for the purpose of safety against displacement, if any, of the elevating mechanism 20 or the horizontal arm unit 30 due to gravity. A procedure for the abnormality handling will be described in detail below by referring to FIG. 9.

The controller 55 controls switching between ON and OFF of the switches 54a and 54b so as to operate the internal brake 43 and the external brake 44 at different timings. The controller 55 has another function, not shown, of obtaining torque values of the servo motors 41 from the servo motors 41 themselves. That is, the controller 55 also functions as a torque value obtaining unit to obtain torque values of the servo motors 41.

Next, a procedure for the diagnosis by the control device 5 relative to the internal brake 43 and the external brake 44 will be described by referring to FIG. 8. FIG. 8 is a flowchart of an exemplary procedure for the diagnosis.

While the diagnosis shown in FIG. 8 is regarding the internal brake 43, the control device 5 also executes similar processing relative to the external brake 44. It will be assumed that prior to the diagnosis, both the switches 54a and 54b are ON, that is, both the internal brake 43 and the external brake 44 are released.

As shown in FIG. 8, the controller 55 of the control device 5 starts a diagnosis by obtaining the current encoder value from the encoder 46. The current encoder value serves as a reference value (step S101). The encoder value obtained here will be referred to as an encoder value A. The controller 55 stores the obtained encoder value A in a storage, not shown, such as a random access memory (RAM).

Next, the controller 55 switches off the switch 54a to operate the internal brake 43 (step S102), and then drives the servo motor 41 (step S103). Then, the controller 55 again obtains an encoder value, which will be referred to as an encoder value B (step S104). The controller 55 determines whether the absolute value of the difference between the obtained encoder value B and the reference encoder value A exceeds a predetermined threshold (step S105).

When the absolute value of the difference between the encoder value A and the encoder value B is not in excess of the predetermined threshold (NO in step S105), the controller 55 determines that the internal brakes 43 is functioning normally (step S106).

That is, when the servo motor 41 is driven and no change occurs to its encoder value, the controller 55 determines that the rotation of the servo motor 41 is appropriately restricted by the internal brake 43 (that is, the internal brake 43 is functioning normally). The controller 55 may notify the determination made in step S106 to the upper controller or other unit.

When the absolute value of the difference between the encoder value A and the encoder value B is in excess of the predetermined threshold (YES in step S105), the controller 55 determines that the internal brake 43 is not functioning normally (step S107), and executes abnormality handling (step S108). Upon ending the processing of step S106 or step S108, the controller 55 ends the diagnosis relative to the internal brake 43.

Thus, the control device 5 determines whether the internal brake 43 or the external brake 44 is functioning normally based on the encoder value of the servo motor 41 when it is activated with the internal brake 43 or the external brake 44 in operation. This facilitates the diagnosis as to whether the internal brake 43 or the external brake 44 is functioning normally.

In this embodiment, the control device 5 starts the diagnosis upon receipt of an instruction from the operating unit or the upper controller. This, however, should not be construed in a limiting sense. The control device 5 may routinely execute the diagnosis.

Next, a procedure for the abnormality handling in step S108 will be described by referring to FIG. 9. FIG. 9 is a flowchart of an exemplary procedure for the abnormality handling.

As shown in FIG. 9, the controller 55 starts abnormality handling by driving the servo motors 41 to move down the elevating mechanism 20 of the robot 1 to a predetermined position (step S201). The predetermined position is, for example, the lower limit of a software-based range in which the control device 5 moves up and down the elevating mechanism 20. Even when the elevating mechanism 20 is moved down to the predetermined position, the horizontal arm unit 30 does not contact the stopper 21a of the base 21.

Next, the controller 55 drives the servo motors 41 to further move down the elevating mechanism 20 (step S202). Thus, the horizontal arm unit 30 is further moved down toward the stopper 21a.

The controller 55 then obtains a torque value from each servo motor 41 (step S203), and determines whether the obtained torque value exceeds a predetermined threshold (step S204). When the obtained torque value is not in excess of the predetermined threshold (NO in step S204), steps S202 to S204 are repeated until the obtained torque value exceeds the predetermined threshold.

When the horizontal arm unit 30 contacts the stopper 21a and cannot move further downward, the torque value of each servo motor 41 increases. When the obtained torque value exceeds the predetermined threshold (YES in step S204), the controller 55 determines that the horizontal arm unit 30 has moved down to its lowest position, and cuts off the supply of electric power to the servo motors 41(step S205), thus ending the processing.

The controller 55 may execute processing of sending information indicating a brake failure to the upper controller or other unit. For example, notifying that the internal brake 43 or the external brake 44 has failed enables the operator or other workers to efficiently execute replacement or other work.

In this embodiment, the abnormality handling is executed when the internal brake 43 or the external brake 44 is detected as failing. This, however, should not be construed in a limiting sense. It is also possible to execute the abnormality handling when both the internal brake 43 and the external brake 44 are detected as failing.

In this case, when either the internal brake 43 or the external brake 44 is detected as failing, the only processing that may follow is, for example, notifying the detected failure to the upper controller or other unit.

Thus, when the control device 5 determines that the internal brake 43 or the external brake 44 is not functioning normally, the servo motors 41 are driven to move the elevating mechanism 20 to its lowest position. This ensures displacement, if any, of the elevating mechanism 20 or the horizontal arm unit 30 due to gravity.

After moving the elevating mechanism 20 to the predetermined position, the control device 5 further drives the servo motors 41 to obtain the torque value of each servo motor 41. When the torque value obtained from each servo motor 41 is in excess of a predetermined value, the control device 5 determines that the elevating mechanism 20 has moved to its lowest position. This ensures more reliable movement of the elevating mechanism 20 to its lowest position.

After moving the elevating mechanism 20 to its lowest position, the control device 5 cuts off the supply of electric power to the servo motors 41. This ensures improved safety of the operator during replacement of brakes or other work.

Thus, the robot according to embodiment 1 includes an internal brake (or external brake) to restrict rotation of the servo motor. The internal brake (or external brake) includes a brake plate, a plurality of pressing members, a helical compression spring, and an electromagnetic coil. The brake plate integrally rotates with the shaft of the servo motor. The plurality of pressing members are movable toward the brake plate. The helical compression spring biases the pressing member toward the brake plate. The electromagnetic coil electromagnetically attracts the pressing member against the biasing force of the helical compression spring when current is on. The helical compression spring biases the plurality of pressing members using mutually different biasing forces. This more reliably prevents displacement of the elevating mechanism or other components.

In embodiment 1, the robot includes an internal brake and an external brake. This enhances the braking force of the brake to restrict rotation of the servo motor, and more reliably prevents displacement of the elevating mechanism or other components.

In embodiment 1, one internal brake 43 and one external brake 44 are provided per servo motor 41. This, however, should not be construed in a limiting sense. One servo motor 41 may include a plurality of internal brakes 43 or a plurality of external brakes 44.

### Embodiment 2

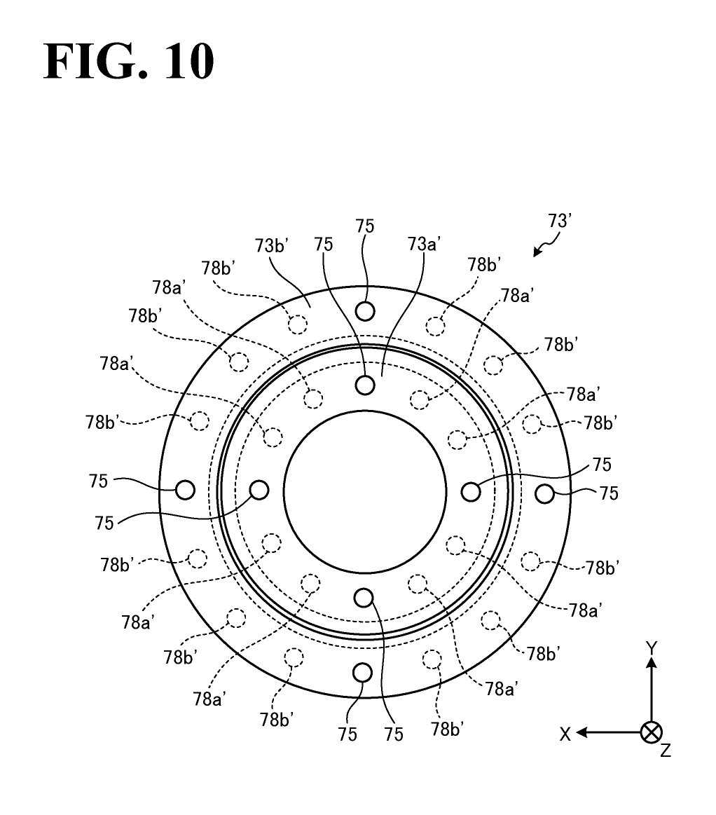

In embodiment 1, the two pressing members 73a and 73b together define a ring shape as shown in FIG. 5. This, however, should not be construed in a limiting sense. A pressing member according to embodiment 2 employing another arrangement will be described by referring to FIG. 10. FIG. 10 is a front view of a pressing member according to embodiment 2.

In embodiment 2, components identical to those in embodiment 1 are designated by the same reference numerals and will not be elaborated upon further here.

As shown in FIG. 10, a pressing member 73′ includes two pressing members 73a and 73b′, which have mutually different radii. In the front view (as viewed in the direction Z), the two pressing members 73a′ and 73b′ define approximately concentric ring shapes. The radius of the pressing member 73a is smaller than the radius of the pressing member 73b′. The pressing area of the pressing member 73a′ is smaller than the pressing area of the pressing member 73b′.

The pressing members 73a′ defines the inner ring of the concentric rings, and is closer to the center of the concentric rings than the 73b′ is to the center of the concentric rings. The pressing member 73a′ includes eight helical compression springs 78a′ to press the pressing member 73a′. The eight helical compression springs 78a′ are disposed approximately throughout the circumference of the pressing member 73a′. The pressing member 73b′ defines the outer ring of the concentric rings, and is further radially outward than the pressing member 73a′. The pressing member 73b′ includes twelve helical compression springs 78b′ to bias the pressing member 73b′. The twelve helical compression springs 78b′ are disposed approximately throughout the circumference of the pressing member 73b′. The helical compression springs 78a and 78b′ are examples of a “biasing member” and a “spring”.

The helical compression springs 78a′ and the helical compression springs 78b′ are mutually different in number and respectively determined based on the pressing areas of the pressing members 73a′ and 73b′. The helical compression springs 78a′ and the helical compression springs 78b′ have the same spring constants.

The pressing member 73a′ includes four guides 75 at 90-degree intervals. The pressing member 73b′ also includes four guides 75 at 90-degree intervals.

Thus, embodiment 2 is different from embodiment 1 in that the plurality of pressing members define approximately concentric rings of mutually different radii. The pressing member defining the outer ring of the concentric rings is biased by helical compression springs using pressing forces different from the pressing forces of helical compression springs that bias the pressing member defining the inner ring of the concentric rings.

The pressing members thus configured provide similar advantageous effects to those in embodiment 1. For example, even when one of the pressing member 73a′ and the pressing member 73b′ fails, the other, non-failing pressing member continues operating, as opposed to the use of a single pressing member. This more reliably prevents displacement of the elevating mechanism 20 or other components. Other advantageous effects are similar to those in embodiment 1.

### Embodiment 3

In the above-described embodiments, the external brake 44c is opposite the servo motor 41c across the reducer main body 421, as shown in FIG. 6. This, however, should not be construed as limiting the position of the external brake.

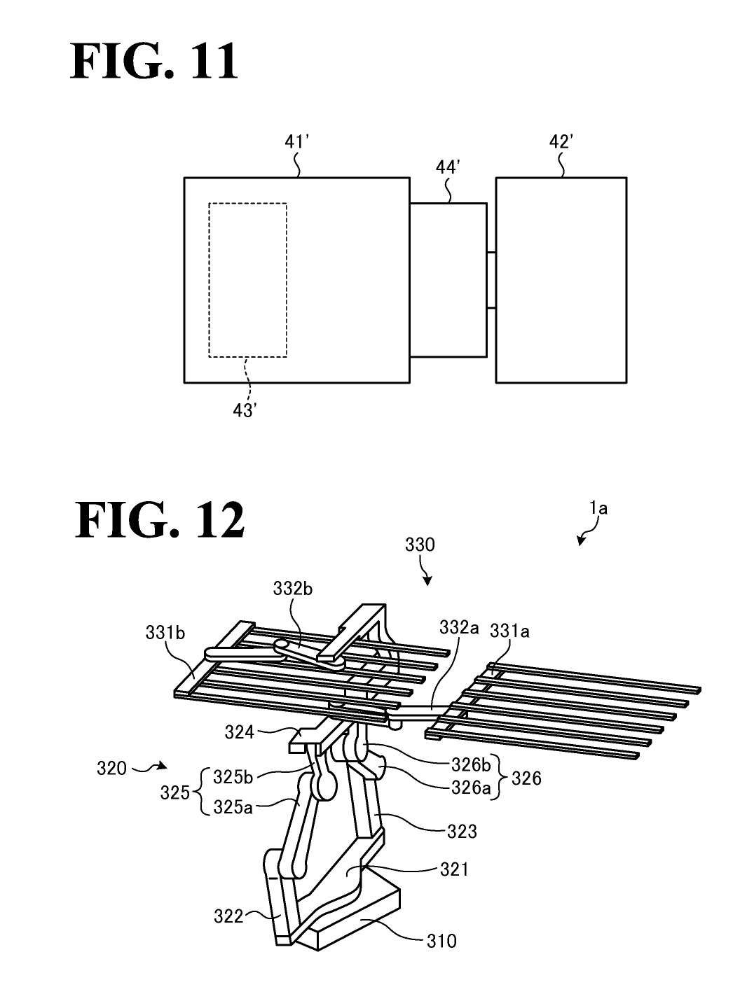

An external brake according to embodiment 3 disposed at another position will be described by referring to FIG. 11. FIG. 11 is a diagram illustrating another exemplary position of the external brake.

As shown in FIG. 11, an external brake 44′ may be disposed, for example, between a servo motor 41′ and a reducer 42′. While in FIG. 11 the external brake 44′ is secured to the servo motor 41′, the external brake 44′ may be secured to the reducer 42′.

Thus, the external brake may be opposite the servo motor 41 across the reducer main body 421, as with the external brake 44 according to embodiment 1, or may be disposed between the servo motor 41′ and the reducer 42′, as with the external brake 44′ according to embodiment 3.

The servo motor 41′ includes an internal brake 43′, similarly to embodiment 1 and embodiment 2. The internal brake 43′ includes a pressing member that may be similar to the pressing member 73 according to embodiment 1 or similar to the pressing member 73′ according to embodiment 2.

### Embodiment 4

While in the above-described embodiments the robot uses a single leg unit to support the horizontal arm unit, this should not be construed as limiting the type of robot.

For example, the robot may use two or more leg units to support the horizontal arm unit. Embodiment 4 is directed to this type of robot, which will be described below by referring to FIG. 12. FIG. 12 is a schematic perspective view of a robot according to embodiment 4.

As shown in FIG. 12, a robot 1 a according to embodiment 4 includes a base 310, an elevating mechanism 320, and a horizontal arm unit 330. The elevating mechanism 320 includes a turning portion 321, pillars 322 and 323, a supporting base 324, and two leg units 325 and 326. The a turning portion 321 is rotatably coupled to the base 310. The pillars 322 and 323 are upright on both ends of the turning portion 321. The supporting base 324 rotatably supports the horizontal arm unit 330. The two leg units 325 and 326 are respectively supported by the pillars 322 and 323 on the base ends, and support the supporting base 324 on the distal ends.

The leg unit 325 includes a first leg 325a and a second leg 325b. The first leg 325a has a base end rotatably supported by the pillar 322. The second leg 325b has a base end rotatably supported by the distal end of the first leg 325a and has a distal end supporting the supporting base 324. Similarly, the leg unit 326 includes a first leg 326a and a second leg 326b. The first leg 326a has a base end rotatably supported by the pillar 323. The second leg 326b has a base end rotatably supported by the distal end of the first leg 326a and has a distal end supporting the supporting base 324.

The horizontal arm unit 330 includes hands 331a and 331b and arms 332a and 332b. The hands 331a and 331b carry workpieces. The arms 332a and 332b has distal ends respectively supporting the hands 331a and 331b. The horizontal arm unit 330 extends and retracts the arms 332a and 332b so as to move the hands 331a and 331b in predetermined directions, similarly to the horizontal arm unit 30 according to embodiment 1.

The elevating mechanism 320 changes the postures of the two leg units 325 and 326 so as to move the horizontal arm unit 330 in vertical directions. The elevating mechanism 320 supports the horizontal arm unit 330 on the two leg units 325 and 326, and thus more reliably holds the horizontal arm unit 330 than the elevating mechanism 20 according to embodiment 1 holds the horizontal arm unit 30.

The elevating mechanism 320 has a first joint and a second joint. At the first joint, the base ends of the first legs 325a and 326a are rotatably coupled to the distal ends of the pillars 322 and 323. At the second joint, the base ends of the second legs 325b and 326b are rotatably coupled to the distal ends of the first legs 325a and 326a. The first and second joints each include a servo motor, a reducer, and an external brake. The servo motor includes an internal brake. The servo motor, the reducer, the internal brake, and the external brake are respectively similar to the servo motor 41, the reducer 42, the internal brake 43, and the external brake 44 according to embodiment 1, or respectively similar to the servo motor 41′, the reducer 42′, the internal brake 43′, and the external brake 44′ according to embodiment 3.

Thus, the robot may use two leg units to support the horizontal arm unit. While in FIG. 12 the robot includes two leg units, this should not be construed in a limiting sense. The number of the leg units may be more than two.

### Embodiment 5

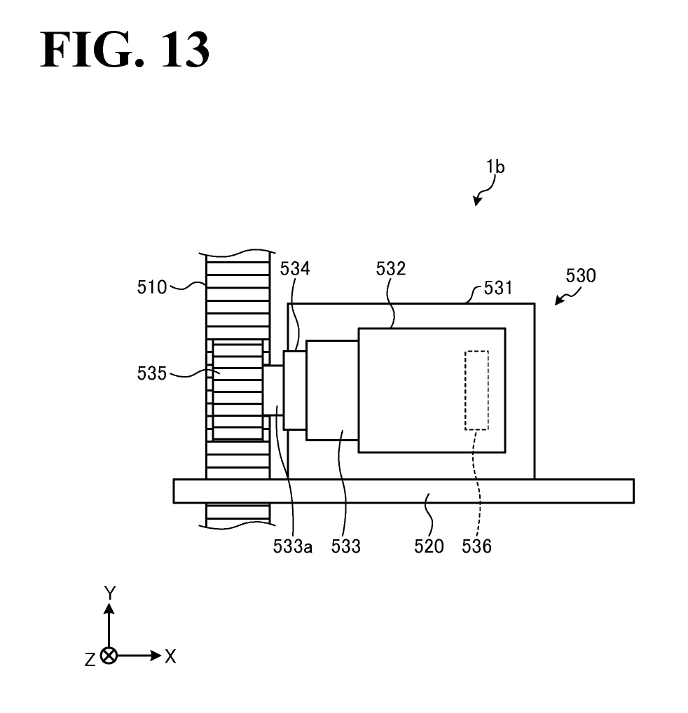

The robot may be, for example, a linear motion transfer robot. Embodiment 5 is directed to this type of robot, which will be described below by referring to FIG. 13. FIG. 13 is a partially enlarged view of a robot according to embodiment 5. In the following description, the direction Y shown in FIG. 13 is assumed a vertical direction.

As shown in FIG. 13, a robot 1b according to embodiment 5 is what is called a rack-and-pinion robot, which converts rotational force to linear motion in the vertical direction. Specifically, the robot 1b includes a rack 510, a linear motion unit 520, and a motor unit 530. The rack 510 extends in the vertical direction. The linear motion unit 520 is held to the rack 510 movably in the vertical direction. The motor unit 530 is disposed on the linear motion unit 520.

The motor unit 530 includes a support 531, a servo motor 532, a reducer 533, an external brake 534, and a pinion gear 535. The support 531 is upright on the linear motion unit 520. The servo motor 532 is secured to the support 531. The reducer 533 decelerates rotation of the servo motor 532 and outputs the decelerated rotation. The external brake 534 restricts the rotation of the servo motor 532. The pinion gear 535 is disposed on a distal end of an output shaft 533a of the reducer 533.

The servo motor 532 includes an internal brake 536, similarly to the servo motors according to above-described embodiments. The pressing member against the internal brake 536 may be similar to the pressing member 73 according to embodiment 1 or similar to the pressing member 73′ according to embodiment 2.

In the robot 1b, the servo motor 532 drives the pinion gear 535 to rotate while engaging with the rack 510, thus moving the linear motion unit 520 in the vertical direction.

In the robot 1b according to embodiment 5, one internal brake 536 and one external brake 534 are provided per servo motor 532, similarly to the above-described embodiments. This enhances the braking force and more reliably prevents displacement due to gravity of the linear motion unit 520, compared with the use of the internal brake 536 alone to restrict rotation of the servo motor 532. Thus, the robot may be a linear motion robot as shown in FIG. 13.

The above-described embodiments employ two brakes, namely the internal brake and the external brake, per servo motor. This, however, should not be construed in a limiting sense. One servo motor may only include either the internal brake or the external brake.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A robot comprising:
a rotating electrical machine comprising a shaft; and
a brake configured to restrict rotation of the rotating electrical machine, the brake comprising:
a brake plate configured to rotate integrally with the shaft of the rotating electrical machine;
a plurality of pressing members movable toward the brake plate and comprising a first pressing member and a second pressing member;
at least one biasing member configured to bias the first pressing member and the second pressing member toward the brake plate using mutually different biasing forces; and
an electromagnetic coil configured to, when current is on, electromagnetically attract the first pressing member and the second pressing member against the biasing forces of the at least one biasing member.

2. The robot according to claim 1, wherein the at least one biasing member comprises at least one spring configured to effect the mutually different biasing forces to the first pressing member and the second pressing member so that the first pressing member and the second pressing member comprise mutually different pressing forces.

3. The robot according to claim 2,
wherein the first pressing member comprises a first pressing area, and
wherein the second pressing member comprises a second pressing area different from the first pressing area in size.

4. The robot according to claim 3, wherein the first pressing member and the second pressing member together define a ring shape comprising a circumferential direction, and comprise mutually different central angles along the circumferential direction.

5. The robot according to claim 4, wherein the at least one spring comprises a plurality of springs comprising same spring constants, the plurality of springs comprising:
first springs configured to bias the first pressing member, a number of the first springs being determined based on the first pressing area of the first pressing member; and
second springs configured to bias the second pressing member, a number of the second springs being determined based on the second pressing area of the second pressing member and different from the number of the first springs.

6. The robot according to claim 3,
wherein the first pressing member defines a first ring shape comprising a first radius,
wherein the second pressing member defines a second ring shape approximately concentric to the first ring shape and comprising a second radius different from the first radius such that the second ring shape is further radially outward than the first ring shape, and
wherein the first pressing member and the second pressing member are biased by the at least one biasing member using mutually different pressing forces.

7. The robot according to claim 1, further comprising:
a horizontal arm unit comprising:
a hand configured to carry an object to be conveyed; and
an arm configured to move the hand in a predetermined direction; and
an elevating mechanism configured to move the horizontal arm unit in a vertical direction using the rotating electrical machine.

8. The robot according to claim 2, further comprising:
a horizontal arm unit comprising:
a hand configured to carry an object to be conveyed; and
an arm configured to move the hand in a predetermined direction; and
an elevating mechanism configured to move the horizontal arm unit in a vertical direction using the rotating electrical machine.

9. The robot according to claim 3, further comprising:
a horizontal arm unit comprising:
a hand configured to carry an object to be conveyed; and
an arm configured to move the hand in a predetermined direction; and
an elevating mechanism configured to move the horizontal arm unit in a vertical direction using the rotating electrical machine.

10. The robot according to claim 4, further comprising:
a horizontal arm unit comprising:
a hand configured to carry an object to be conveyed; and
an arm configured to move the hand in a predetermined direction; and
an elevating mechanism configured to move the horizontal arm unit in a vertical direction using the rotating electrical machine.

11. The robot according to claim 5, further comprising:
a horizontal arm unit comprising:
a hand configured to carry an object to be conveyed; and
an arm configured to move the hand in a predetermined direction; and
an elevating mechanism configured to move the horizontal arm unit in a vertical
direction using the rotating electrical machine.

12. The robot according to claim 6, further comprising:
a horizontal arm unit comprising:
a hand configured to carry an object to be conveyed; and
an arm configured to move the hand in a predetermined direction; and
an elevating mechanism configured to move the horizontal arm unit in a vertical direction using the rotating electrical machine.
